(19) United States
(12) Patent Application Publication
(10) Pub. No.: US 2024/0250486 A1
(43) Pub. Date: Jul. 25, 2024

(54) MANUFACTURING METHOD FOR TERMINAL-EQUIPPED ELECTRIC WIRE

(71) Applicant: YAZAKI CORPORATION, Tokyo (JP)

(72) Inventor: Kenzo Tanaka, Makinohara-shi (JP)

(21) Appl. No.: 18/401,249

(22) Filed: Dec. 29, 2023

(30) Foreign Application Priority Data
Jan. 23, 2023 (JP) 2023-007736

(51) Int. Cl. H01R 43/00

(52) U.S. Cl. CPC H01R 43/005; H01R 4/185

(57) ABSTRACT

In a manufacturing method for a terminal-equipped electric wire, an anticorrosive that is a liquid photocurable resin is applied to a bonding part between a crimp terminal and an electric wire in the electric wire to which the crimp terminal is attached, whether a predetermined allowable time has elapsed after an end of the applying is determined, the anticorrosive applied to the bonding part is temporarily irradiated with light in a case where it is determined that the allowable time has elapsed by the determining, and the anticorrosive applied to the bonding part or the anticorrosive temporarily irradiated with light is cured.

### CROSS-REFERENCE TO RELATED APPLICATION(S)

The present application claims priority to and incorporates by reference the entire contents of Japanese Patent Application No. 2023-007736 filed in Japan on Jan. 23, 2023.

### BACKGROUND OF THE INVENTION

### 1. Field of the Invention

The present invention relates to a manufacturing method for a terminal-equipped electric wire.

### 2. Description of the Related Art

In one example of the conventionally known manufacturing method for a terminal-equipped electric wire, an anticorrosive is applied and cured on a bonding part between a electric wire and a terminal, so that the bonding part between the electric wire and the terminal is sealed from the outside to prevent corrosion, as described in Japanese Patent Application Laid-open No. 2015-153721, Japanese Patent Application Laid-open No. 2016-225171, Japanese Patent Application Laid-open No. 2015-153715, and Japanese Patent Application Laid-open No. 2014-130703.

In such a manufacturing method, if the anticorrosive is not applied in a region where the anticorrosive should be applied in the bonding part between the electric wire and the terminal, the proper anticorrosion performance cannot be achieved. The anticorrosive is liquid before curing and has flowability when applied to the bonding part. Therefore, it is difficult to ensure the proper anticorrosion function unless the anticorrosive is applied as appropriate to the bonding part between the electric wire and the terminal in consideration of such properties.

### SUMMARY OF THE INVENTION

In view of this, it is an object of the present invention to provide a manufacturing method for a terminal-equipped electric wire with a proper anticorrosion function, in which an anticorrosive is applied as appropriate to a bonding part between an electric wire and a terminal.

In order to achieve the above mentioned object, a manufacturing method for a terminal-equipped electric wire according to one aspect of the present invention includes applying an anticorrosive that is a liquid photocurable resin to a bonding part between a crimp terminal and an electric wire in the electric wire to which the crimp terminal is attached; determining whether a predetermined allowable time has elapsed after an end of the applying; temporarily irradiating the anticorrosive applied to the bonding part by the applying with light in a case where it is determined that the allowable time has elapsed by the determining; and curing the anticorrosive applied to the bonding part or the anticorrosive temporarily irradiated with light.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic structure of an electric wire manufactured by a manufacturing method for a terminal-equipped electric wire according to an embodiment;

FIG. 2 is a block diagram illustrating an outline of an electrical structure of a manufacturing apparatus used for the manufacturing method for a terminal-equipped electric wire according to the embodiment;

FIG. 3 is a diagram illustrating application positions of an anticorrosive in the manufacturing method for a terminal-equipped electric wire according to the embodiment;

FIG. 4 is an explanatory view of an application step and a temporary irradiation step of the manufacturing method for a terminal-equipped electric wire according to the embodiment;

FIG. 5 is an explanatory view illustrating a curing step of the manufacturing method for a terminal-equipped electric wire according to the embodiment; and

FIG. 6 is a flowchart expressing the manufacturing method for a terminal-equipped electric wire according to the embodiment.

### DETAILED DESCRIPTION OF THE PREFERRED EMBODIMENTS

An embodiment of the present invention will hereinafter be described in detail based on the drawings. Note that the present invention is not limited by the following embodiment. In addition, the components in the following embodiment include those that can be replaced and easily conceived by persons who are skilled in the art, or those that are substantially the same.

### Embodiment

A manufacturing method for a terminal-equipped electric wire according to an embodiment of the present invention will be described.

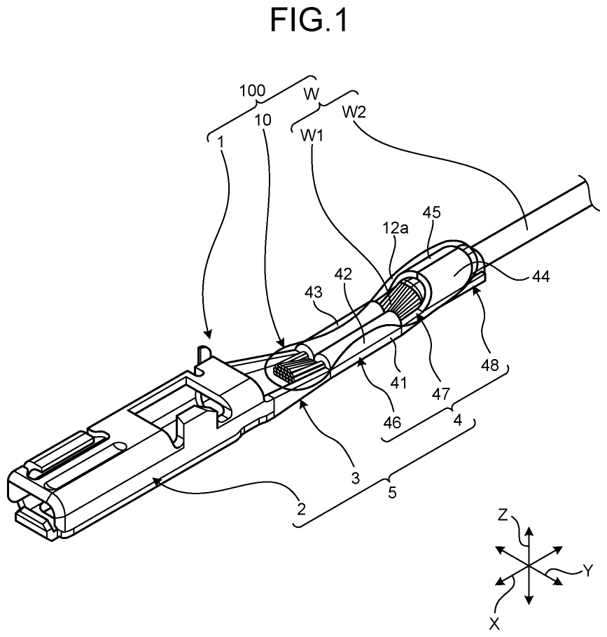

FIG. 1 is a perspective view illustrating a schematic structure of an electric wire manufactured by the manufacturing method for a terminal-equipped electric wire according to the embodiment. The manufacturing method for a terminal-equipped electric wire according to this embodiment is a method for manufacturing a terminal-equipped electric wire 100 illustrated in FIG. 1. Prior to the explanation of the manufacturing method for a terminal-equipped electric wire, a fundamental configuration of the terminal-equipped electric wire 100 illustrated in FIG. 1 will be explained. After that, the manufacturing method for the terminal-equipped electric wire 100 will be described in detail.

As illustrated in FIG. 1, the terminal-equipped electric wire 100 is a terminal-equipped electric wire equipped with a terminal fitting at an end part of an electric wire W, and for example, is usable for a wire harness used in a vehicle or the like. Here, one example of the wire harness is formed in a manner that a plurality of the electric wires W used for power supply or signal communication are made into a bundle as an assembly component and the electric wires W are connected at one time to each device mounted on a vehicle through a connector or the like, thereby connecting between the devices. The terminal-equipped electric wire 100 according to this embodiment includes the electric wire W, a crimp terminal 1, and a sealing part 10.

In the following description, of first, second, and third directions that intersect with each other, the first direction is referred to as an “axial direction X,” the second direction as a “width direction Y,” and the third direction as a “height direction Z”. Here, the axial direction X, the width direction Y, and the height direction Z are orthogonal to each other. The axial direction X corresponds to an extending direction of the electric wire W to which the crimp terminal 1 is attached. The width direction Y and the height direction Z correspond to intersecting directions that intersect with the axial direction X. The directions used in the following description indicate those in a state where the parts are assembled together unless otherwise stated. Note that being orthogonal here includes being almost orthogonal.

The electric wire W includes, for example, a conductor part W1 that has a conductive property and has a linear shape, and an insulating covering part W2 that has an insulating property and covers an outer side of the conductor part W1. In other words, the electric wire W is an insulating electric wire in which the conductor part W1 is covered with the insulating covering part W2. The conductor part W1 in this embodiment is a core wire formed by binding a plurality of strands of conductive metal, such as copper, copper alloy, aluminum, or aluminum alloy. This conductor part W1 may be a twisted core wire made by twisting a plurality of strands together. The insulating covering part W2 is an electric wire cover that covers an outer peripheral side of the conductor part W1. The insulating covering part W2 is, for example, formed by extruding and molding an insulating resin material (PP, PVC, cross-linked PE, etc. The material is selected suitably in consideration of abrasion resistance, chemical resistance, heat resistance, or the like). In at least one end of the conductor part W1 of the electric wire W, the insulating covering part W2 is stripped off and the one end of the conductor part W1 is exposed from an end of the insulating covering part W2. To this exposed end of the conductor part W1, the crimp terminal 1 is crimped. Here, the electric wire W is formed so as to extend with substantially the same diameter with respect to the extending direction extending linearly. The cross-sectional shape of the conductor part W1 (the cross-sectional shape in a direction intersecting with the extending direction) is approximately circular, and the cross-sectional shape of the insulating covering part W2 is approximately annular; thus, the cross-sectional shape of the whole is approximately circular.

The crimp terminal 1 is a component for connecting the electric wire W to another component, and includes an electric connection part 2, a coupling part 3, and an electric wire bonding part 4. The electric connection part 2, the coupling part 3, and the electric wire bonding part 4 are integrally formed of conductive metal, such as copper, copper alloy, aluminum, or aluminum alloy, and constitute a terminal fitting 5. The crimp terminal 1, for example, is formed by pressing and bending a piece of sheet metal punched into a shape corresponding to each part of the electric connection part 2, the coupling part 3, the electric wire bonding part 4, or the like, so that the respective parts are integrally formed three-dimensionally. In the crimp terminal 1, the electric connection part 2, the coupling part 3, and the electric wire bonding part 4 are arranged in this order and coupled to each other from one side to the other side along the axial direction X.

The electric connection part 2 is a part that is electrically connected to a conductive member. The conductive member in this embodiment is, for example, a counterpart terminal (not illustrated). In other words, here, the electric connection part 2 in this embodiment is configured as a terminal connection part that is electrically connected to the counterpart terminal. The electric connection part 2 may have either a male terminal shape or a female terminal shape. The electric connection part 2 in this embodiment is illustrated as having a female terminal shape, which is electrically connected to the counterpart terminal with a male terminal shape. The conductive member does not have to be the counterpart terminal, and may be, for example, various types of conductive members, such as a grounding member. The electric connection part 2 does not have to constitute the terminal connection part that is electrically connected to the counterpart terminal and may have, for example, a so-called round terminal (LA terminal) shape that is fastened to a grounding member or the like.

The coupling part 3 is a part that exists between the electric connection part 2 and the electric wire bonding part 4 and couples the electric connection part 2 and the electric wire bonding part 4 to each other. In the crimp terminal 1, the electric connection part 2 and the electric wire bonding part 4 are electrically connected through the coupling part 3, and the electric connection part 2 and the conductor part W1 of the electric wire W are electrically connected and become conductive through the electric wire bonding part 4.

The electric wire bonding part 4 is a part that connects the crimp terminal 1 and the electric wire W. The electric wire bonding part 4 is caulked and crimped at an end of the electric wire W. The electric wire bonding part 4 includes a base part 41 and two pairs of barrel piece parts 42 and 43, and 44 and 45. The base part 41 is a part that extends along the axial direction X and serves as a bottom wall of the U-shaped electric wire bonding part 4. The end part of the electric wire W is placed on the base part 41 in a crimping process. One side of the base part 41 in the axial direction X is coupled to the electric connection part 2 through the coupling part 3. The pair of barrel piece parts 42 and 43 are parts that are formed extending in a strip shape from the base part 41 to each side of the width direction Y, and that wrap the conductor part W1 of the electric wire W between the base part 41 and the pair of barrel piece parts 42 and 43, and are caulked and crimped. The pair of barrel piece parts 42 and 43 are illustrated as the barrel piece parts that are caulked and crimped, which are so-called B-crimps. In other words, the pair of barrel piece parts 42 and 43 are bent toward the base part 41 with the entire periphery of the electric wire W wrapped and crimped. In this state, the caulking and crimping are performed so that the tips of the pair of barrel piece parts 42 and 43 are each pressed in contact with the conductor part W1. The pair of barrel piece parts 42 and 43 are not limited to this type, and may be overlap crimps, for example. In this case, the pair of barrel piece parts 42 and 43 may be configured so that the tip sides overlap with each other when the pair of barrel piece parts 42 and 43 are wound around the electric wire W, caulked, and crimped. The pair of barrel piece parts 44 and 45 are parts that are formed extending in a strip shape from the base part 41 to each side of the width direction Y, and that wrap the insulating covering part W2 of the electric wire W between the base part 41 and the pair of barrel piece parts 44 and 45, and are caulked and crimped. The pair of barrel piece parts 44 and 45 are illustrated as the parts using so-called round crimps. In other words, the caulking and crimping are performed in the positional relation that when the pair of barrel piece parts 44 and 45 wrap the insulating covering part W2 and are crimped, the tips of the pair of barrel piece parts 44 and 45 face each other and are in contact with each other. The pair of barrel piece parts 44 and 45 are not limited to this type, and may be overlap crimps, for example. In this case, the pair of barrel piece parts 44 and 45 may be configured so that the tip sides overlap with each other when the pair of barrel piece parts 44 and 45 are wound around the electric wire W, caulked, and crimped. The electric wire bonding part 4 is caulked and crimped to the electric wire W by the base part 41 and two pairs of barrel piece parts 42 and 43, and 44 and 45.

The electric wire bonding part 4 includes a conductor crimp part 46, a conductor exposed part 47, and a covering crimp part 48. The conductor crimp part 46 is formed by a part of the base part 41 and the pair of barrel piece parts 42 and 43, and wraps, caulks, and crimps the conductor part W1 of the electric wire W. The conductor exposed part 47 is formed between the conductor crimp part 46 and the covering crimp part 48 and is formed by a part of the base part 41. In the conductor exposed part 47, the conductor part W1 is exposed. The covering crimp part 48 is formed by a part of the base part 41 and the pair of barrel piece parts 44 and 45, and wraps, caulks, and crimps the insulating covering part W2 of the electric wire W. In the electric wire bonding part 4, the conductor crimp part 46, the conductor exposed part 47, and the covering crimp part 48 are arranged in this order from the electric connection part 2 side to the opposite side along the axial direction X.

The sealing part 10 seals the bonding part where the electric wire W and the crimp terminal 1 are bonded, from the outside, and is formed by applying and curing an anticorrosive. As the anticorrosive, for example, a photocurable resin is used. Specifically, the anticorrosive is an ultraviolet (UV)-curable resin that is cured by irradiation with UV rays. Examples of the UV-curable resins include, but not limited to, urethane acrylate resins. The sealing part 10 is formed by applying a liquid anticorrosive to an application region set in the bonding part between the electric wire W and the crimp terminal 1, and irradiating the applied anticorrosive with light so as to cure the anticorrosive.

The manufacturing method for a terminal-equipped electric wire according to this embodiment will be described next.

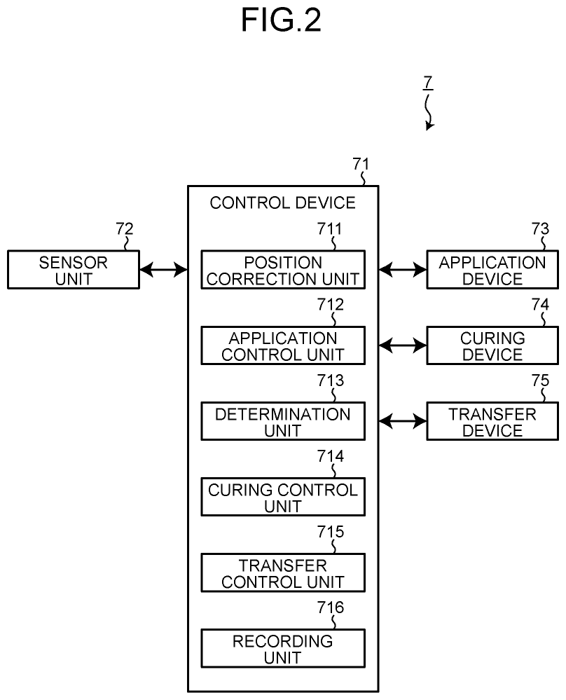

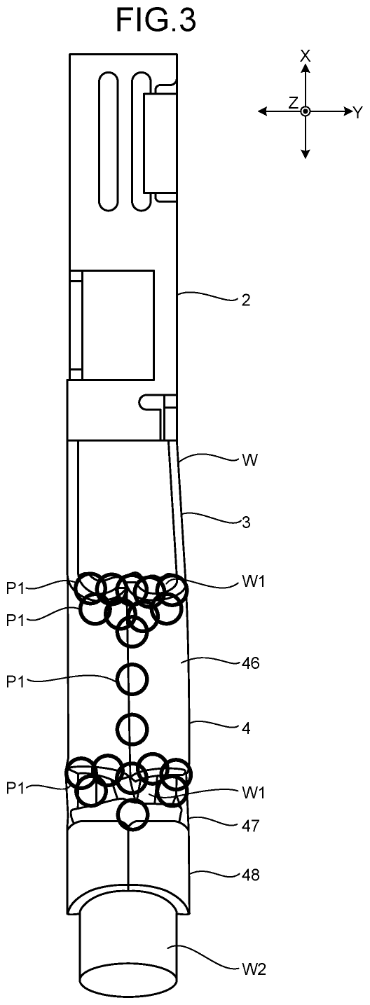

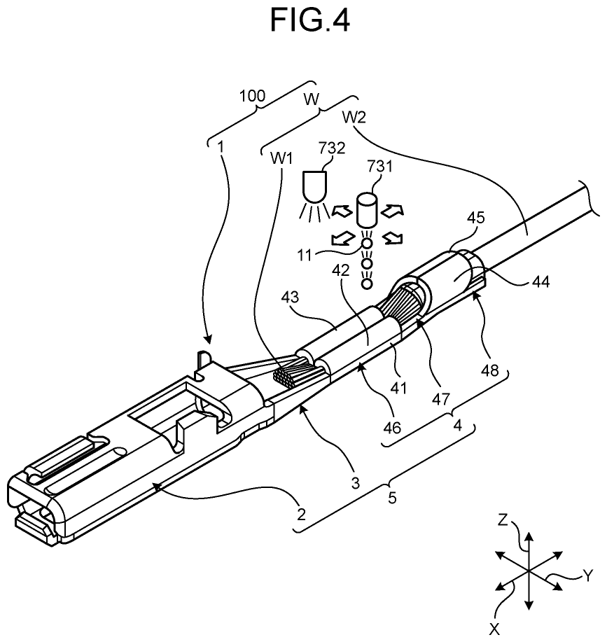

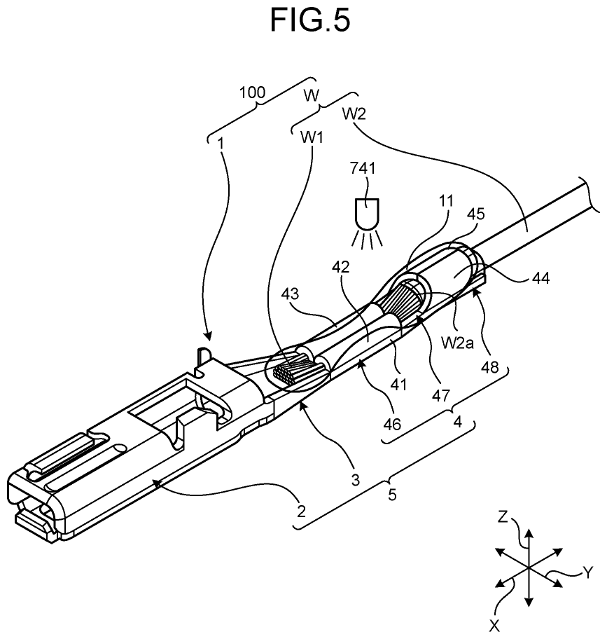

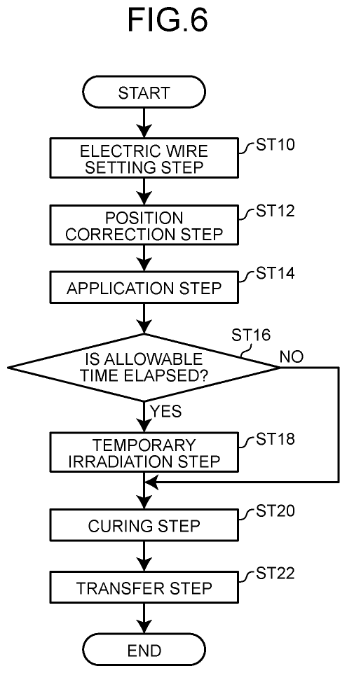

FIG. 2 is a block diagram illustrating the outline of an electrical structure of a manufacturing apparatus used for the manufacturing method for a terminal-equipped electric wire according to the embodiment, and FIG. 3 is a diagram illustrating application positions of the anticorrosive in the manufacturing method for a terminal-equipped electric wire according to the embodiment. FIG. 4 is an explanatory view of an application step and a temporary irradiation step of the manufacturing method for a terminal-equipped electric wire according to the embodiment, FIG. 5 is an explanatory view illustrating a curing step of the manufacturing method for a terminal-equipped electric wire according to the embodiment, and FIG. 6 is a flowchart expressing the manufacturing method for a terminal-equipped electric wire according to the embodiment.

The manufacturing method for a terminal-equipped electric wire according to this embodiment may be performed by a manufacturing apparatus or manually by workers. Here, description is made of a case where electric wires are manufactured by a manufacturing apparatus. As illustrated in FIG. 2, a manufacturing apparatus 7 is an apparatus for manufacturing the terminal-equipped electric wire 100, and manufactures the terminal-equipped electric wire 100 by applying the anticorrosive to the electric wire W to which the crimp terminal 1 is attached, and curing the applied anticorrosive.

The manufacturing apparatus 7 includes a control device 71, a sensor unit 72, an application device 73, a curing device 74, and a transfer device 75. The control device 71 performs each control in a manufacturing process of the manufacturing apparatus 7, and includes, for example, a computer having a processor such as a central processing unit (CPU), and a memory such as read only memory (ROM) or a random access memory (RAM). This manufacturing apparatus 7 manufactures the terminal-equipped electric wire 100 by forming the sealing part 10 on the electric wire W with the crimp terminal 1 attached thereto, and this apparatus may also have functions to perform other processes such as assembling the electric wire W with the crimp terminal 1 attached thereto.

The sensor unit 72 is an imaging sensor and an imaging unit that captures images of the electric wire W with the crimp terminal 1 attached thereto, where the anticorrosive is applied and cured. The sensor unit 72, for example, captures images of the electric wire W with the crimp terminal 1 attached thereto from above (height direction Z) and inputs the captured image data to the control device 71. The control device 71 includes a position correction unit 711, an application control unit 712, a determination unit 713, a curing control unit 714, a transfer control unit 715, and a recording unit 716. The position correction unit 711, the application control unit 712, the determination unit 713, the curing control unit 714, and the transfer control unit 715 are configured, for example, by introducing computer programs that perform the respective functions to the control device 71. The position correction unit 711, the application control unit 712, the determination unit 713, the curing control unit 714, and the transfer control unit 715 may be separately installed in the control device 71 as control units that perform the respective functions.

The position correction unit 711 corrects the coordinate position for the image of the electric wire W with the crimp terminal 1 attached thereto, in order to set the application position where the anticorrosive is applied. For example, the position correction unit 711 detects a characteristic part of the crimp terminal 1 on the basis of the image of the electric wire W with the crimp terminal 1 attached thereto that is input from the sensor unit 72, sets the coordinate for the crimp terminal 1 to set the application region, and corrects the position of the coordinate as necessary. The position correction unit 711 then sets the application position where the anticorrosive should be applied to the bonding part between the crimp terminal 1 and the electric wire W in the electric wire W with the crimp terminal 1 attached thereto. For example, as illustrated in FIG. 3, a plurality of application positions P1 are set at different locations and are set within the range where the conductor part W1 is exposed at the bonding part between the crimp terminal 1 and the electric wire W in the electric wire W with the crimp terminal 1 attached thereto. Specifically, the application positions P1 are set at a place of the conductor exposed part 47 between the covering crimp part 48 and the conductor crimp part 46, at a place of a center position of the conductor crimp part 46, and at a place of the conductor part W1 extending from the conductor crimp part 46. The bonding part between the crimp terminal 1 and the electric wire W in the electric wire W with the crimp terminal 1 attached thereto is, for example, a region where the electric wire bonding part 4 is provided in the crimp terminal 1 attached to the electric wire W and a region around the electric wire bonding part 4.

The application control unit 712 outputs control signals to the application device 73 to control the application of the liquid anticorrosive to the bonding part between the crimp terminal 1 and the electric wire W in the electric wire W with the crimp terminal 1 attached thereto. In other words, the application control unit 712 operates the application device 73 so that the anticorrosive is applied to the application positions P1 set by the position correction unit 711. As illustrated in FIG. 4, the application device 73 includes a nozzle 731 that applies the anticorrosive 11 to the bonding part between the crimp terminal 1 and the electric wire W. The nozzle 731 is configured to be movable in the axial direction X and the width direction Y, for example, and is capable of discharging or jetting the anticorrosive 11 drop by drop to the application positions P1 described above. Since the nozzle 731 discharges or jets the anticorrosive 11, the anticorrosive 11 can be accurately applied to the application positions.

The application device 73 also includes a light source 732 that irradiates the anticorrosive 11 applied to the electric wire W with the crimp terminal 1 attached thereto, with the UV rays. The light source 732 is attached to the nozzle 731 and functions as a temporary irradiation part for temporary irradiation. The light source 732 operates when a predetermined allowable time has elapsed after the anticorrosive 11 is applied, and irradiates the applied anticorrosive 11 with the UV rays. Thus, the outflow of the applied anticorrosive 11 from the application region is suppressed.

The determination unit 713 determines whether the predetermined allowable time has elapsed since the end of the application of the anticorrosive 11 by the application device 73. The allowable time is set based on the anticorrosive data, including the amount and viscosity of the applied anticorrosive 11, and is set to be the time that the applied anticorrosive 11 will not flow out of the application region. The manufacturing apparatus 7 is programmed so that, for example, if there is a human body inside the apparatus, the transfer of the electric wire W is stopped for safety reasons. If such a stop occurs and recovery from this stop takes time, the allowable time may elapse after the application of the anticorrosive 11 and before the curing. In this case, the applied anticorrosive 11 may flow out of the application region. Therefore, the determination unit 713 determines whether the allowable time has not elapsed.

The curing control unit 714 outputs control signals to the curing device 74 to control the light irradiation to the anticorrosive 11 applied to the electric wire W with the crimp terminal 1 attached thereto. For example, the curing control unit 714 operates the curing device 74 so as to irradiate the anticorrosive 11 with the UV rays after the anticorrosive 11 is applied to the electric wire W with the crimp terminal 1 attached thereto. As illustrated in FIG. 5, the curing device 74 includes a light source 741 that irradiates the bonding part between the crimp terminal 1 and the electric wire W with the UV rays. The anticorrosive 11 irradiated with the UV rays by the light source 741 is cured to become the sealing part 10.

The transfer control unit 715 controls the transfer of the electric wire W with the crimp terminal 1 attached thereto. For example, the control signal is output to a transfer mechanism, which is not illustrated, to transfer the electric wire W with the crimp terminal 1 attached thereto. Specifically, the transfer control unit 715 causes the transfer mechanism to transfer the electric wire W, whose anticorrosive 11 has been cured by the curing device 74, to the outside and dispense the electric wire W.

The recording unit 716 is a memory that records control information related to electric wire manufacturing. For example, the recording unit 716 records application position data, allowable time data, light irradiation timing data, and the like.

Next, each step of the manufacturing method for a terminal-equipped electric wire according to this embodiment will be described in detail.

FIG. 6 is a flowchart expressing the manufacturing method for a terminal-equipped electric wire. The flowchart in FIG. 6, for example, is started when the electric wire W with the crimp terminal 1 attached thereto is installed at the application position and is executed by the control device 71.

First, as expressed by a step ST10 (hereinafter simply referred to as “ST10”. The same shall apply to the subsequent steps ST), an electric wire setting step is performed. The electric wire setting step is a step of setting the electric wire W with the crimp terminal 1 attached thereto at the position where the application and curing are performed, and recognizing the completion of setting. This electric wire setting may be performed by a transfer mechanism not illustrated in the drawing, or may be performed manually by workers. The fact that the electric wire W with the crimp terminal 1 attached thereto is set at the predetermined position may be recognized, for example, based on a detection signal (image signal) of the sensor unit 72.

The process then advances to ST12, where a position correction step is performed. The position correction step is a step of setting the coordinate for an image of the electric wire W with the crimp terminal 1 attached thereto, and correcting the position of the coordinate as necessary. The coordinate is used to set the application position where the anticorrosive 11 is to be applied. The anticorrosive 11 is applied based on the coordinate value of this coordinate. For example, the position correction unit 711 detects the characteristic part of the crimp terminal 1 in the image of the electric wire W with the crimp terminal 1 attached thereto that is input from the sensor unit 72, and corrects the position of the coordinate with respect to the electric wire W with the crimp terminal 1 attached thereto. The position correction unit 711 then sets the application position P1 where the anticorrosive 11 should be applied to the electric wire W with the crimp terminal 1 attached thereto.

The process then advances to ST14, where the application step is performed. The application step is a step of applying the anticorrosive 11 to the bonding part between the crimp terminal 1 and the electric wire W with the crimp terminal 1 attached thereto. For example, a control signal is output from the application control unit 712 to the application device 73, and the anticorrosive 11 is discharged from the nozzle 731 of the application device 73. The anticorrosive 11 is applied by adhering to a predetermined position on the electric wire W with the crimp terminal 1 attached thereto. The anticorrosive 11 is applied to the predetermined application positions P1 as illustrated in FIG. 3. At this time, a drop of the anticorrosive 11 is discharged for each application position P1, and the anticorrosive 11 is applied.

The process then advances to ST16 in FIG. 6, where it is determined whether the allowable time has elapsed since the application step ended. For example, the determination unit 713 determines whether the allowable time has elapsed since the application by the application device 73 ended. At this ST16, if the allowable time has not elapsed since the application step ended and the curing step is ready to start, the process advances to the curing step at ST20. The case in which the curing step is ready to start means a case in which, for example, a normal process has been performed at each step and the curing device 74 is ready to operate. On the other hand, a case in which the curing step is not ready to start means a case in which, for example, a process is stopped in the step prior to ST16, and the process cannot proceed to the curing step.

If it is determined at ST16 that the allowable time has elapsed since the application step ended, the temporary irradiation step is performed (ST18). The temporary irradiation step is a step in which the anticorrosive 11 applied to the electric wire W with the crimp terminal 1 attached thereto is temporarily irradiated with the UV rays. For example, as illustrated in FIG. 4, the UV rays are emitted from the light source 732 and delivered onto the anticorrosive 11 applied to the electric wire W with the crimp terminal 1 attached thereto. This temporary irradiation with the UV rays temporarily cures the anticorrosive 11. The amount of UV irradiation at this time is less than the amount of UV irradiation at the curing step described below. For example, the UV irradiation time at the temporary irradiation step is shorter than the UV irradiation time at the curing step described below, or the illuminance of the UV rays at the temporary irradiation step is lower than the illuminance of the UV rays at the curing step described below. By this temporary irradiation step, the outflow of the applied anticorrosive 11 from the application region can be suppressed.

Then, at ST20 in FIG. 6, the curing step is performed. The curing step is a step in which the anticorrosive 11 applied to the electric wire W with the crimp terminal 1 attached thereto is irradiated with the UV rays. For example, as illustrated in FIG. 5, the UV rays are emitted from the light source 741 and delivered onto the anticorrosive 11 applied to the electric wire W with the crimp terminal 1 attached thereto, thereby curing the anticorrosive 11. By the curing of the anticorrosive 11, the sealing part 10 is formed.

The process then advances to ST22 in FIG. 6, where the transfer step is performed. The transfer step is a step of transferring the electric wire W with the sealing part 10 formed to the outside of the manufacturing apparatus 7 by a transfer mechanism not illustrated in the drawing. After completing the transfer step of ST22, a series of control processes in FIG. 6 is terminated.

As described above, in the manufacturing method for a terminal-equipped electric wire according to this embodiment, if the predetermined allowable time has elapsed since the end of the application step, the anticorrosive 11 applied at the application step is temporarily irradiated with the light. Thus, the outflow of the anticorrosive 11 applied at the application step from the application region can be suppressed. Therefore, by applying the anticorrosive 11 as appropriate, the terminal-equipped electric wire 100 with the proper anticorrosion performance can be manufactured.

For example, in a case where the anticorrosive 11 applied at the application step is not irradiated temporarily after the predetermined allowable time from the end of the application step, the anticorrosive 11 applied at the application step may flow out of the application region. In this case, the anticorrosive 11 is applied outside the application region, and the proper terminal-equipped electric wire 100 cannot be manufactured. If the anticorrosive 11 flows toward the electric connection part 2, the proper functioning of the terminal-equipped electric wire 100 may be interrupted. In contrast, the manufacturing method for a terminal-equipped electric wire according to this embodiment avoids such a risk, and by applying the anticorrosive 11 as appropriate, it is possible to manufacture the terminal-equipped electric wire 100 with the proper anticorrosion performance.

The manufacturing method for a terminal-equipped electric wire according to the embodiment of the present invention described above is not limited to the above-described embodiment, and various changes can be made within the scope of claims. The manufacturing method for a terminal-equipped electric wire according to this embodiment may be configured by combining the components described in the embodiment and modifications described above as appropriate.

For example, in the manufacturing method for a terminal-equipped electric wire according to the embodiment described above, the application region of the anticorrosive is set based on the image data of the sensor unit 72 and the application position and the application order are set for the application region; however, in the case where the electric wire W with the crimp terminal 1 attached thereto is set at a predetermined reference position, the anticorrosive 11 may be applied in a predetermined application region at a predetermined application position. Even in this case, the same effect can be obtained as that in the above-mentioned manufacturing method for a terminal-equipped electric wire.

In the manufacturing method for a terminal-equipped electric wire according to the present embodiment, the anticorrosive is applied as appropriate to the bonding part between the electric wire and the terminal in the terminal-equipped electric wire, so that the proper anticorrosion function can be secured.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A manufacturing method for a terminal-equipped electric wire, comprising:
applying an anticorrosive that is a liquid photocurable resin to a bonding part between a crimp terminal and an electric wire in the electric wire to which the crimp terminal is attached;
determining whether a predetermined allowable time has elapsed after an end of the applying;
temporarily irradiating the anticorrosive applied to the bonding part by the applying with light in a case where it is determined that the allowable time has elapsed by the determining; and
curing the anticorrosive applied to the bonding part or the anticorrosive temporarily irradiated with light.
